(19) United States
(12) Patent Application Publication
(10) Pub. No.: US 2004/0238251 A1
(43) Pub. Date: Dec. 2, 2004

(54) Small and lightweight snow vehicle

(76) Inventors: Shay Oron, Scarsdale, NY (US); Itzik Oron, Holon (IL)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/858,107

(22) Filed: Jun. 1, 2004

Related U.S. Application Data
(60) Provisional application No. 60/475,363, filed on Jun. 2, 2003.

(51) Int. Cl. B62M 27/02

(52) U.S. Cl. 180/180

(57) ABSTRACT

A lightweight highly maneuverable vehicle capable of traveling on multiple surfaces is disclosed. The driver of the vehicle is in a substantially standing position. The vehicle uses a track drive and a single steering mechanism. The track is driven with a gas or electric motor.

### CROSS-REFERENCE TO RELATED APPLICATIONS

This application claims priority to provisional patent application number 60/475,363, filed Jun. 2, 2003, incorporated herein by reference.

### BACKGROUND OF THE INVENTION

This invention relates to a tracked vehicle or other track-propelled land vehicle, and more specifically to a lightweight maneuverable vehicle where the driver maintains a substantially standing position.

As can be seen by reference to the following U.S. Pat. Nos. D305,134; 4,653,766; 5,192,089 and 5,620,189, the prior art is replete with myriad and diverse wheeled vehicles.

People frequently recreate in cold climates and in snowy conditions. In several types of recreational activities that take place in snowy or icy conditions, the individual rides up a mountain on a mechanical conveyance and then, at the summit of the mountain, slides down the snowy slopes of the mountain. Such activities include skiing, snowboarding, sledding, and the like. In these types of activities, flat or uphill portions of the mountain reduce one's rate of travel and generally one's enjoyment of the activity. If one stops on a flat or uphill portion of the mountain, building up the momentum to overcome gravity and friction and begin traveling again (and especially to remain traveling) can be an arduous task. Cross-country skis are designed to allow a person to travel on flat portions of land, however they are not ideal for downhill portions of land. Similarly, downhill skis are typically only useful for traveling downhill and are less than desirable for flat portions of land.

People also like to recreate on bicycles. Some individuals have combined typical cold weather activities such as skiing and conventional bicycling in developing a “snow bike.” Examples of snow bikes are found in U.S. Pat. No. 2,633,365 to Cwynar et al., U.S. Pat. No. 3,561,783 to Ellett, U.S. Pat. No. 4,027,891 to Frame, and U.S. Pat. No. 4,059,168 to House.

The Ellett and Frame devices are essentially bicycle frames with the wheels replaced with short skis. Neither provides any ability for a user to use force to propel the vehicle. The Ellett and Frame devices are limited to use on downhill slopes. The user is intended to wear short skis on his or her feet while operating the snow bike for stability.

The Cwynar device is described as a “ski scooter” and is intended to be used by a standing individual. The user keeps one foot on the running board and pushes off the ground with the other foot in a manner similar to propelling a conventional scooter. Instead of wheels, the Cwynar device includes runners, one in the front and two in the rear. The use of one's foot to propel a wheeled scooter on ordinary ground is difficult enough; however, additional problems arise when using such a device on snow or ice. For example, the coefficient of friction between a person's foot and snow/ice is substantially smaller than that between a person's foot and a paved road; one could easily slip when trying to propel the device. Also, on snow that is not uniformly packed down, a person may step into a patch of snow that is deeper and more loosely packed than the person expected, resulting in the person losing his balance and falling from the scooter.

The House device converts a standard bicycle frame by adding skis and a fan on the rear of the frame. The motor-driven fan is intended to create sufficient thrust to propel a person across a snowy field. Because the pedals of the bicycle frame are no longer attached to any resistance-providing structure, a user cannot obtain much exercise benefit from use of this device.

Another device that enables a person to propel a personal vehicle over snow/ice was described in U.S. Pat. No. D551,442 to Korff. Korff modified a standard bicycle frame by replacing the front wheel with a guide runner and by adding a rear runner behind it. The rear wheel was left in place and stud plates were placed around the circumference thereof. A user would pedal the device thus causing the rear wheel to turn. Because the wheel was provided with studs for better traction, and because the runners exhibit reduced coefficient of friction, the device would be propelled across snow/ice. However, even with the studs on the wheel, such a device will slip on ice because only a small portion of the wheel tread is in contact with the ice at any given moment. Moreover, no braking mechanism is provided.

All of the above devices suffer from several deficiencies. The Ellett and Frame devices do not allow a user any ability to use force to propel the vehicle. The Cwynar device is difficult to operate and unreliable owing to the non-uniform nature of snow and ice. Moreover, much like a conventional snowmobile, the fan required to propel an average weight person is likely to be enormous, heavy, loud, and impractical. Further, none of the above-mentioned devices allow the user to brake or reduce speed in any safe manner. The user must also, in each device listed above, use the respective devices in a single mode only; no provision is made for increasing the mechanical advantage a person has for an inclined surface and/or decreasing the mechanical advantage when riding on downhill slopes. The prior devices also fail to teach a device capable of switching between a motorized or motor-assisted mode of operation and a manual mode. Also, none of the devices mentioned above are suitable for extremely arduous or difficult maneuvering at high speeds, in what is commonly referred to as “extreme sporting” events

Electric scooters are used to move people from place to place at a low speed. The conventional electric scooter substantially comprises a frame, at least one front wheel, one rear wheel, an optional seat, an electric motor and a steering bar. The wheels are rotatably mounted on the frame. The seat is mounted on the frame for a user to sit. The electric motor is mounted on the frame to drive the rear wheel. The steering bar is pivotally mounted on the frame and is connected to each front wheel. The user can control the direction of the electric scooter by means of pivoting the steering bar relative to the frame.

Typical scooters have very small, relatively hard wheels. Because of the small wheel size and relatively poor traction characteristics, scooters with bicycle like steering column and fork arrangements result in design compromises that favor low speed maneuverability and maintaining vertical orientation of the steering axis to the ground.

Motor driven or pedal powered snow vehicles are designed for a sitting user with a single seat and two foot rests and emulate the steering and balancing characteristics of motorcycles and bicycles. These large and cumbersome snow vehicles include a frame, a seat, two foot supports, a swing arm, a track carriage, an endless loop track, a snow compacting ramp, an elongated steering member and a ski. The swing arm pivots upon the frame and angles downward behind the frame. The track circulates a fixed path around the track carriage. The track carriage extends forward from a pivot connection with the rear of the swing arm, and pivots vertically under the swing arm in scissors-fashion. The snow vehicle is suspended upon the track carriage using a single shock absorber and load-distributing bell crank. A snow compacting ramp attached to the track carriage compresses the snow ahead of the track. The steering member is like the front suspension fork of a motorcycle or bicycle, and is connected to the frame so that it rotates about a steering axis. The ski is mounted to the lower portion of the steering member. However, these snow vehicles are not lightweight or maneuverable. Additionally, these vehicles require many additional and heavy parts such as snow compacting ramps.

### SUMMARY OF THE INVENTION

To overcome the shortcomings of the prior art, the present invention provides an improved frame and overall assembly to provide a lightweight maneuverable off road vehicle where the driver is in a substantially standing position.

### BRIEF DESCRIPTION OF THE DRAWINGS

FIG. 1 is an overview of one embodiment of the invention.

FIG. 2 is a detailed view of one embodiment of the front suspension of the invention.

FIG. 3 is another embodiment of the front steering skid.

FIG. 4 is one embodiment of the drive train.

FIG. 5 is a depiction of the drive gear.

FIG. 6 is a portion of the drive belt.

FIG. 7 is one embodiment of the suspension for the vehicle frame.

FIG. 8 is another embodiment of the suspension for the vehicle frame.

FIG. 9 is one embodiment of the lower portion of the vehicle frame.

FIG. 10 is one embodiment of the ski lock assembly, shown in an unlocked position.

### DETAILED DESCRIPTION OF THE INVENTION

The disclosed vehicle offers a lightweight, maneuverable and sturdy vehicle that is capable of traveling on multiple surfaces including snow, dirt, grass, and the like.

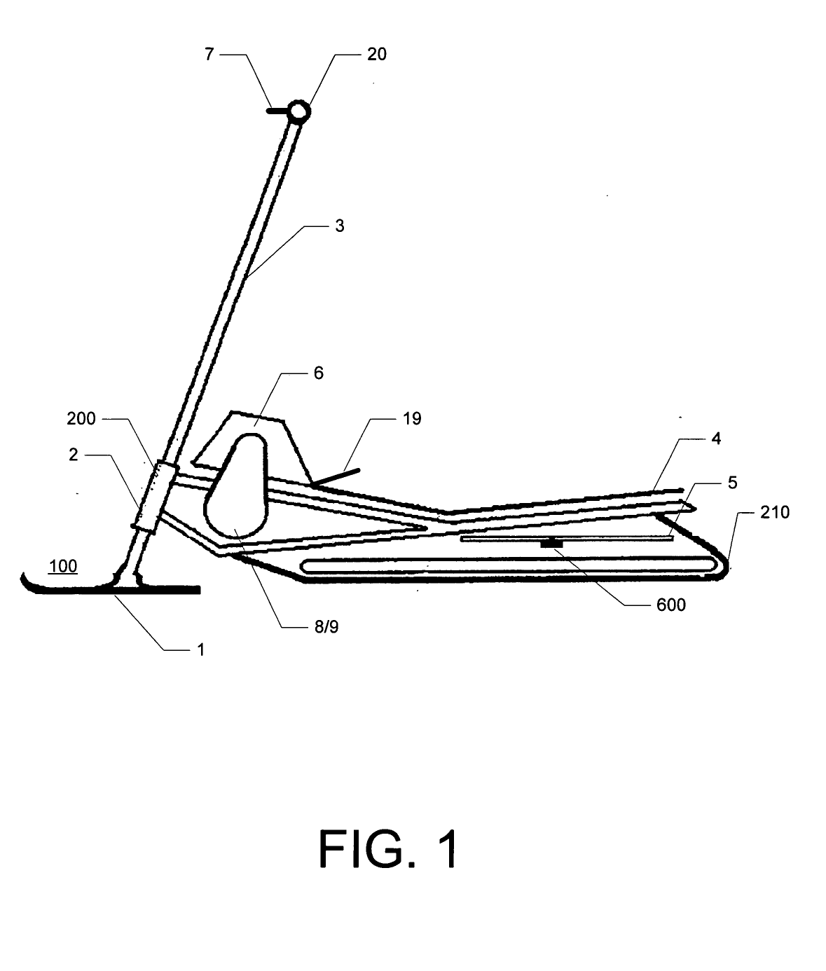

FIG. 1 shows one embodiment of the invention. The vehicle shown in FIG. 1 is a small, lightweight snow vehicle. The vehicle is especially suited for travel on snow and ice covered surfaces but can also be adapted to travel on sand, dirt, mud, or other off-road or on-road surfaces.

The vehicle has nine major components. These include steering means 100, frame 200, riding platforms 4 and 5, motor 6, drive belt 210, brake 8 and drive means 9.

Steering is accomplished using steering means 100, handle bars 20, and steering column 3. In a preferred embodiment, the steering mechanism 1 is a ski. The direction of the vehicle is controlled by turning the ski using steering column 3 and handlebars 20. In one embodiment of the invention, the steering column 3 pivots at the point 2 using pivot means 170 where it is attached to the frame 200. In this manner, the user of the vehicle does not have to lean to assist turning because the ski 1 tilts in response to the tilting of the steering column 3 to enhance the turning of the vehicle.

The frame 200 has mounted upon it a motor 6 which can be a gas or electric motor. In a preferred embodiment of the invention, the motor is mounted in the front of the frame. However, the motor may be mounted at the rear portion of the frame or positioned within the frame and drive track as discussed below.

The motor 6 drives a drive belt 210 that moves the vehicle. The drive belt is driven by a belt, gears, drive shaft, worm gear, chain, or other known drive method. A brake is used to stop the vehicle from forward motion. The brake can be a drum brake, a disc brake or other style friction brake. The brake can be controlled using a hand lever mounted on handle bar 7 or a foot pedal 19 mounted to the frame 200.

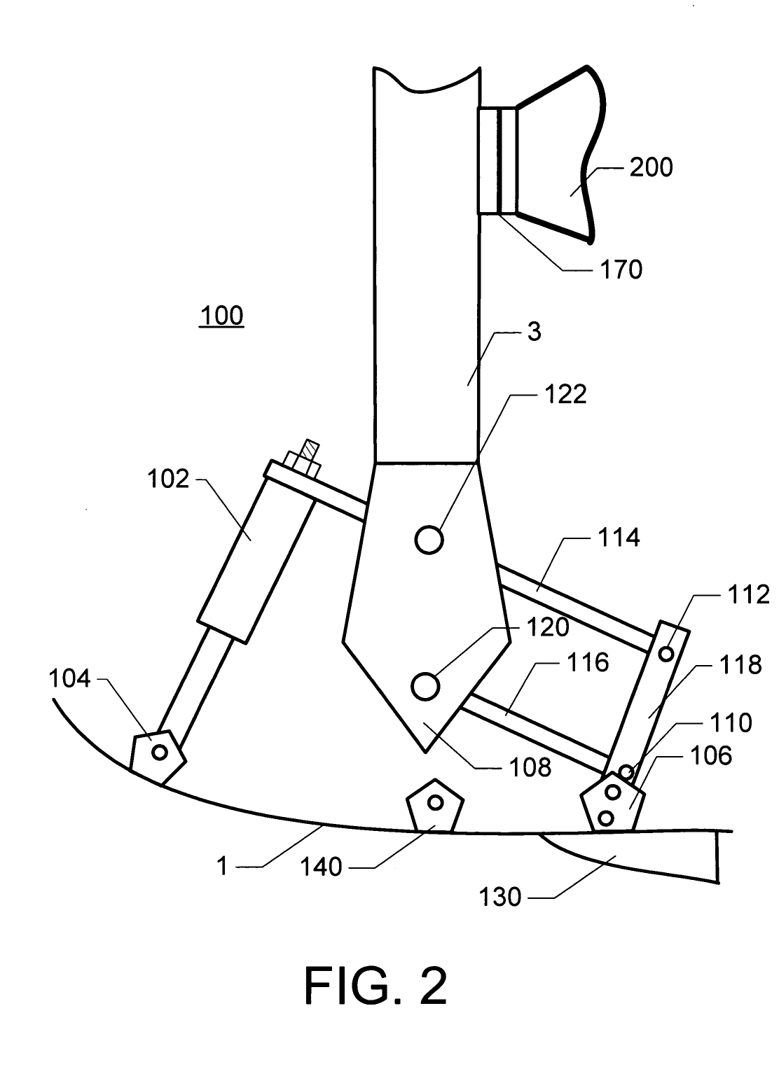

FIG. 2 is a detailed view of one embodiment of front steering assembly 100. As shown, the steering column 3 is connected to the ski using a combination of a shock absorber 102 and attaching members 114, 116 and 118. The shock absorber 102 is a piston-type shock absorber mounted towards the front of the ski 1. Alternately, the shock can be a coil-over shock absorber, an air shock, or the like. Further, the shock absorber can be mounted towards the rear of the ski 1 or, alternately there can be no shock absorber. The first end of the shock absorber 102 is mounted to the ski at connection block 104. The second end of the shock absorber 102 is coupled to connecting member 114 which is connected to vertically-disposed member 118. Vertically-disposed member 118 and member 114 are connected to each other at pivot point 112. Further, vertically disposed member 118 is connected to member 116 at pivot point 110. Member 116 is pivotably attached to the steering column 3 at pivot 120. Member 114 is also pivotably connected to steering column 3 at pivot 122. In yet another embodiment, the substantially vertical member 118 can be replaced with a second shock absorber such that both the front and rear of the ski 1 are pivotably connected to steering column 3 through shock absorbers. In one embodiment of the invention, the ski 1 has a rudder 130 which aids in cutting through the snow to better control the vehicle. In another embodiment, steering column 3 mounts directly to ski 1 at mounting block 140. In yet another embodiment, steering column 3 mounts to ski 1 at block 140 through shock absorbers 7 and 24.

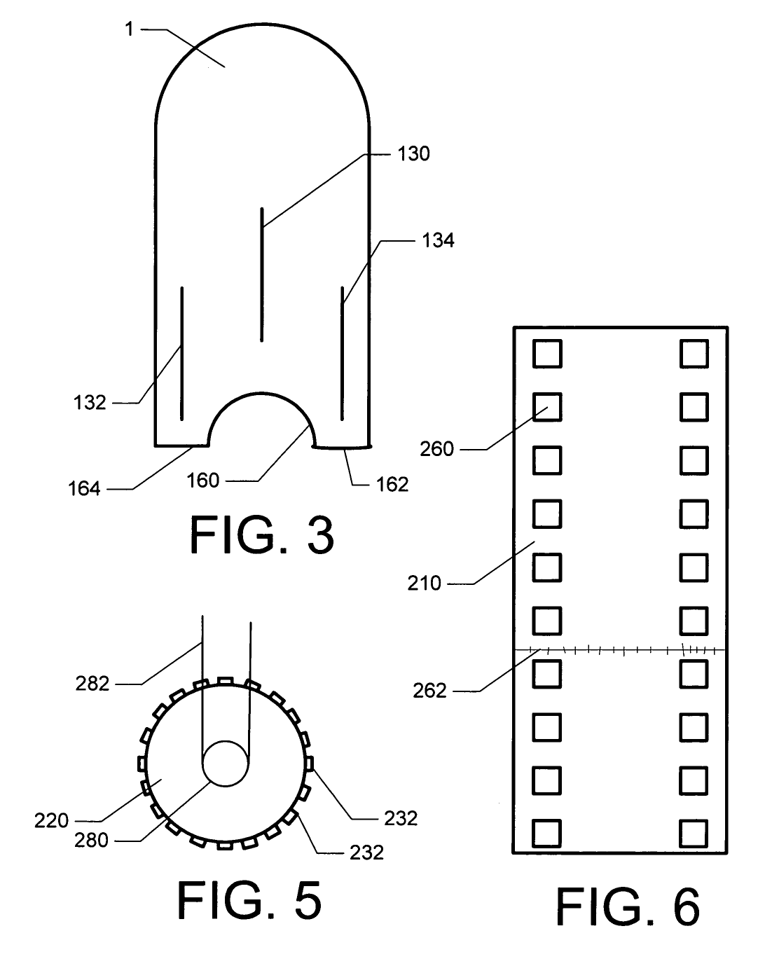

As shown in FIG. 3, the front ski 1 may also have multiple rudders 130, 132, and 134. These rudders help cut through the snow and assist in controlling the vehicle. In another embodiment of the invention, an arcuate section 160 is formed in the ski 1. The arcuate section 160 leaves ski portions 162 and 164 which aid in controlling and steering the vehicle. In another embodiment, the ski 1 is replaced with a wheel (not shown) for off-road use, which may also be connected to the steering column with or without suspension, i.e., with or without shock absorbers.

As discussed above, the control of the vehicle is enhanced by various rudders and formations on the ski 1. Further, when the steering column 3 is pivotably attached to the frame 200 using pivot means 170, the ski 1 is able to lean and cut the snow better resulting in better control.

In another embodiment of the invention, a shock absorber is integrally formed into the steering column 3. This shock absorber can be mounted either above or below attachment point 2 where the steering column 3 meets the frame 200. In one embodiment of the invention, the steering column 3 is collapsible. It can collapse either telescopically or it can fold.

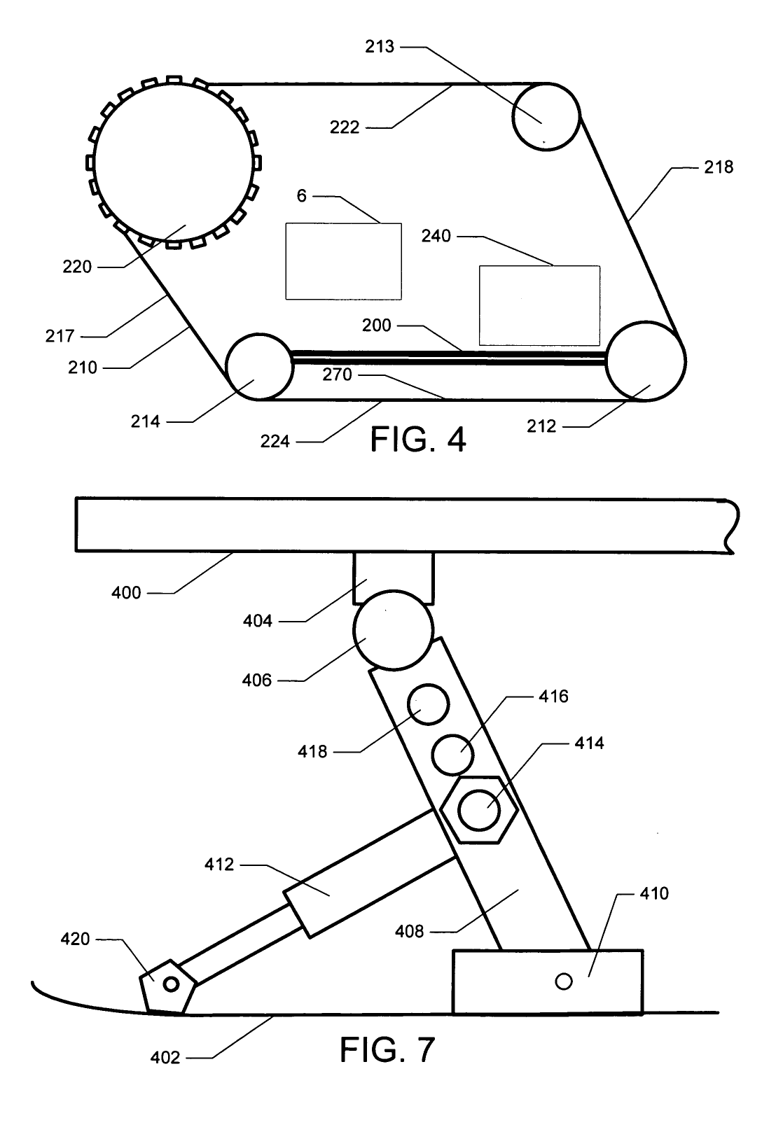

FIG. 4 shows one embodiment of the drive belt 210. In one embodiment of the invention, the drive belt 210 rides on three rollers 213, 213 and 214 and is driven by a drive wheel 220. The wheels or rollers, prevent the belt 210 from contacting the frame. Further, as the frame adjusts, the outer perimeter of the belt stays the same such that the belt always remains taught on the drive gear 220. The upper and lower portions of the drive belt 222 and 224 remain substantially parallel to one another as do side portions 217 and 218 during the operation of the vehicle. The placement of the drive pulleys 210, 212 and 214 is not crucial as long as the drive belt 210 is held in place and contacts the drive gear 220 with sufficient surface area. Preferably, the rollers are situated so that a maximum surface are of drive wheel 220 engages drive belt 210.

In one embodiment, the trapezoidal area formed by the drive belt 210 is large enough to house the motor 6 as well as power means 250. The power means can be a gas tank, diesel tank, power cell, or the like.

As shown in FIG. 5, one embodiment of the drive gear 220 has protrusions 232 which mate with the drive belt 210. Further, in one embodiment, the drive gear 220 has a smaller gear 280 which is connected by driving means 282 to the motor 6. The driving means 282 can be a belt, chain, gears or the like. In another embodiment (not shown), a drive shaft is used to drive the drive gear 220 using a worm gear, universal joint, or the like.

FIG. 6 is a view of one embodiment of the drive belt 210. The belt 210 has holes 260 which mate with the teeth 232 on the drive gear 220. The holes 260 also allow snow to pass through and collect on the inside of the drive belt 270, shown in FIG. 4. The snow that collects on the inside of the drive belt 270 acts as a lubricant to aid the sliding of the drive belt 210 on the frame 200.

In one embodiment of the invention, the drive belt 210 has a seam 262. This seam is held together using a hinge-type assembly. Each end of the drive belt has a portion of a hinge assembly through which a pin is inserted thereby holding the two ends of the belt together. In another embodiment, each end of the belt has a series of loops through which a U-shaped pin is inserted. Alternately, the belt can be stitched together such that it is held taught on the rollers.

The frame 200 comprises an upper member 400 and a lower member 402. The frame 200 can be made from plastic, carbon fiber, aluminum, stainless steel, titanium, fiberglass, or any other material. The lower member 402 is shown in more detail in FIG. 9, discussed below. As shown in FIG. 7, the upper member 400 is pivotably connected to the lower member 402. While the upper and lower frame members are shown being pivotably connected to absorb and reduce bumps, the upper and lower frame members can be fixedly attached to each other. A mounting block 404 connects to pivot 406 which is then coupled to member 408. Member 408 is connected to mounting block 410. The mounting block 410 is fixedly connected to lower member 402. Member 408 has multiple mounting holes 414, 416, and 418. These mounting holes receive one end of shock absorber 412. The other end of shock absorber 412 is pivotably attached to the lower member 402 at pivot mount 420. The various attachment positions 414, 416 and 418 on member 408 vary the stiffness of the ride of the vehicle. As shown in FIG. 7, the front portion of member 402, section 422 is curved upwards. Section 422 acts as the leading edge of the lower member 402. It is curved upwards so that there is not a sharp edge contacting the belt 210 thereby abrading or cutting it. In another embodiment of the invention, member 408 is fixedly attached to support member 404 and no shock absorber 412 is needed. While shock absorber 412 is shown as a standard spring or hydraulic type shock absorber, a coil over shock absorber or other type shock absorber can be used.

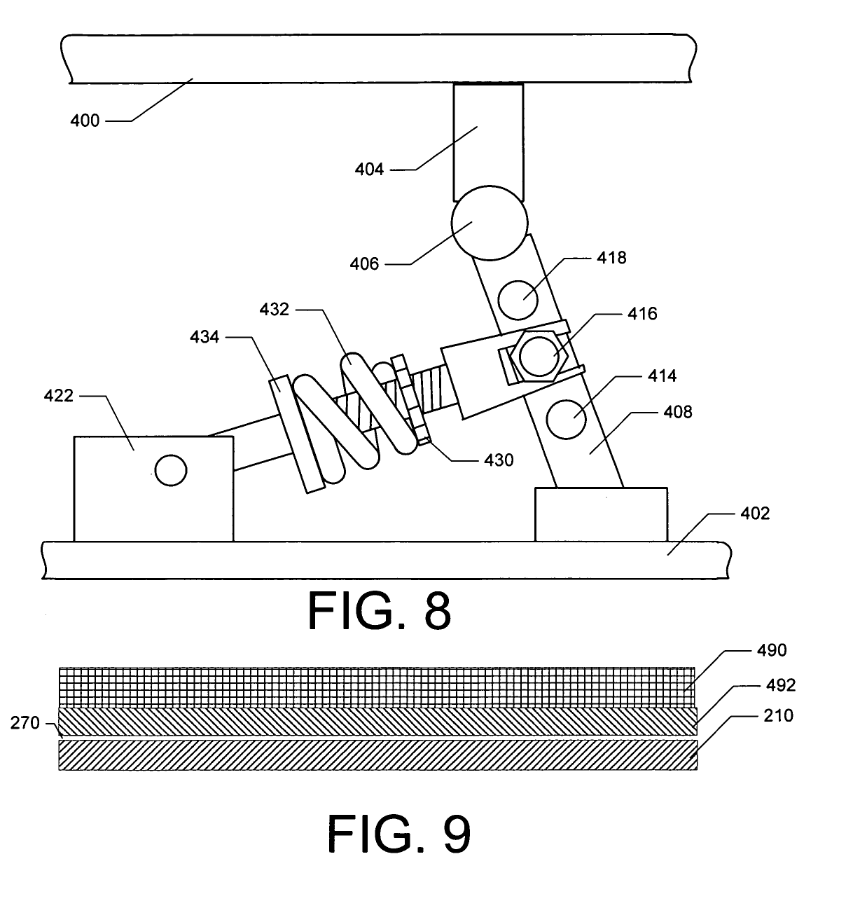

A second suspension element for the vehicle is shown in FIG. 8. As shown, a coiled spring is used for a shock absorber connecting the pivot mounting block 422 to member 408. The shock absorber is adjustable. A spring 432 is mounted between a base 434 and an adjustment ring 430. To change the stiffness of this suspension element, the first end of the spring absorber can be mounted in any one of holes 414, 416, or 418. Further, the adjustment ring 430 can vary the compression of the spring 432 thereby varying the overall stiffness of the suspension.

Typically, the vehicle will have two suspension assemblies, although more or less can be used. A first suspension assembly is typically mounted towards the front of the frame and a second suspension assembly is typically mounted towards the rear of the frame. However, in one embodiment, no suspension is used and the upper member 400 is fixedly attached to the lower member 402. Alternatively, a simple suspension assembly is used. The shock absorbers are adjusted by changing the angle at which the shock absorber attaches to the members. In one embodiment, all of the shock absorbers are adjustable including those on the front ski. The shock absorbers can be any type of shock absorber known to the art such as gas shocks, oil shocks, spring shocks, air shocks, and the like.

As shown in FIG. 9, the lower member 402 consists of a first member 490, and a second layer 492 bonded to the first member 490. The second layer 492 is Teflon, plastic, or any other low-coefficient of friction material. Finally, as shown in FIG. 9, the belt 210 is beneath the lower member 402. A slight space 270 exists between belt 210 and the friction-reducing element 492. The space is filled with snow during typical operation. Alternatively, a series of roller bearings (not shown) can be installed on the lower portion of the frame such that the belt 210 rides on the roller bearings.

The frame 200 has supports for the brake, the steering column, the motor, the track, rollers, the platform, and an auxiliary platform.

The motor 6 is a gas or electric motor. As discussed, it could be mounted at various locations on the frame 200. The motor preferably uses a spring clutch. The speed control for the motor is mounted in the handlebar 20. In one embodiment of the invention, the vehicle uses a three-speed automatic or manual transmission. Other speeds or gearings can also be used, as is well known in the art. Further, the motor can have a magneto or other power-generating device such that lights, a radio, or other electrical devices can be used on the vehicle. Additionally, when an electric motor is used, electric devices can be powered by the fuel cell.

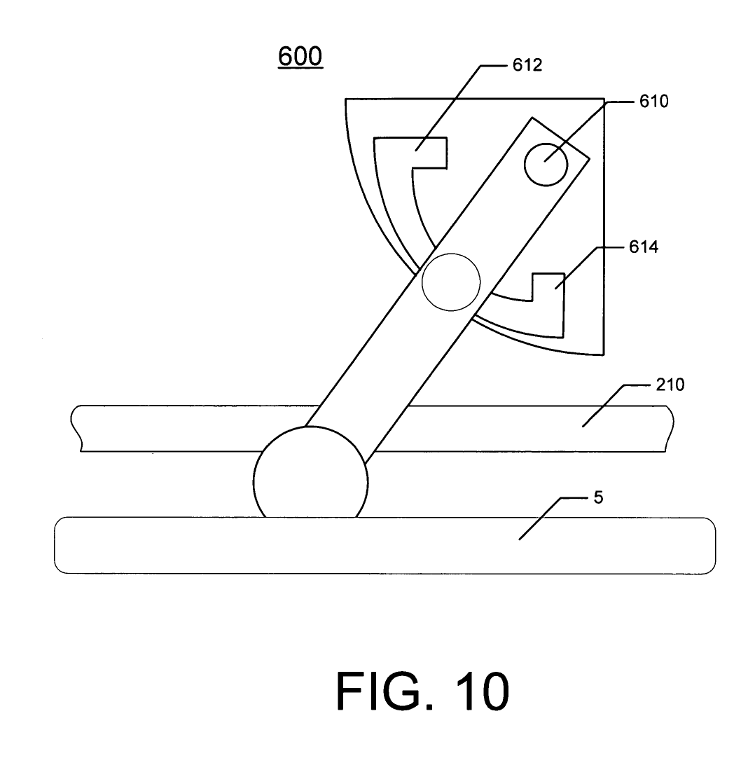

The main platform 4 is mounted to the upper frame member 400. In one embodiment, the main platform is mounted using rubber grommets or the like so that the platform itself has some suspension qualities. The main platform 4can be made from wood, plastic, carbon fiber, aluminum, stainless steel, titanium, fiberglass or the like. Main platform 4 is positioned so that the user is in a sitting position. Auxiliary platforms 5 are mounted to the frame 200 using mount 600. In one embodiment of the invention, the auxiliary mounts are pivotably movable so that the lower portion of the auxiliary platforms 5 function as ski. When the ski function of auxiliary platform 5 is used, the belt 210 is raised from contacting the snow such that the entire vehicle is a ski device. The auxiliary platforms 5 can either automatically or manually pivot about mount 610, shown in FIG. 10, so that it will lock in either the up position 612 or the ski position 614. As auxiliary platform 5 moves from the upper to lower position is preferably remains substantially parallel to the main platform 4.

The riding platform 4 preferably has a non-skid surface. The non-skid surface can be patterned or cover the entire surface of platform 4. In one embodiment, the riding platform is approximately 8 to 16 inches wide and approximately 36 to 61 inches long.

The frame can be adapted so that it can hold skis or a snowboard. Further, the frame 200 can have a small trunk or cargo holder. Additionally, a trailer hitch can be provided on the frame so that the vehicle can pull a trailer. The front of the frame 200 can have a plow mount so that a plow can be mounted to the front of the vehicle and the vehicle could be used to plow.

In one embodiment of the invention, the main platform 4 can have a seat removably attached thereto such that the rider can sit on the seat while the rider's feet are on either the platform 4 or the auxiliary platform 5.

Although the present invention was discussed in terms of certain preferred embodiments, the description is not limited to such embodiments. Rather, the invention includes other embodiments including those apparent to a person of ordinary skill in the art.

What is claimed is:

1. A lightweight vehicle, comprising:
a frame;
a single main a single main platform, which supports a user mounted to a top of the frame;
a motor mounted to the frame;
a first drive wheel coupled to the motor;
a track carriage mounted to the frame;
an endless loop track having a lower run beneath the track carriage and an upper run,
the track carriage bearing upon the lower run of the track;
a second drive wheel coupled to the track;
drive means connecting the first and second drive wheels; and
a steering unit rotatably coupled to the frame.

2. The drive means of claim 1 wherein the drive means are selected from the group consisting of chains, gears, and belts.

3. The motor of claim 1 wherein the drive means are selected from the group consisting of gas motors and electric motors.

4. The vehicle of claim 1, further comprising brake means adapted to slow said endless track.

5. The vehicle according to claim 1, wherein the track carriage is substantially a parallelogram, the parallelogram having four vertices, at least two of the vertices have means upon which the track can move.

6. The device according to claim 5, wherein the second drive wheel is coupled to the track at one of the vertices.

7. The device according to claim 5, wherein the second drive wheel is coupled to the track on a side of the parallelogram.

8. A device for carrying a user comprising:
a surface-contacting module, the surface-contacting module having a track adapted to move the device over a surface, the surface-contacting module being a component of an assembly;
a single main platform which supports the user mounted to a top of the assembly, the single main platform adapted for carrying a user;
a motorized drive module, mounted to the assembly, the motorized drive module causing the track to rotate; and
a steering assembly rotatably attached to the assembly for steering the device.

9. The device according to claim 8, further comprising at least one shock-absorber assembly mounted on the surface-contacting module adapted to lessen shocks to the user.

10. The device according to claim 9, wherein the single main platform, the ground-contacting module, and the motorized drive module are arranged in parallel along a vertical plane.

11. The device according to claim 10 wherein the single main platform is adapted for the user to stand on in an upright position.

12. The device according to claim 8, wherein the motorized drive module is actuatable by the user.

13. The device according to claim 12, wherein the motorized drive module is variably actuatable by the user.

14. The device according to claim 8, further comprising at least one shock-absorber assembly mounted on the steering assembly.

15. The device according to claim 8, further comprising at least one adjustable shock-absorber assembly mounted on the surface-contacting module.

16. The device according to claim 8, further comprising brake means adapted to slow the surface-contacting module.

17. The device according to claim 8, wherein the surface-contacting module is substantially a parallelogram, the parallelogram having four vertices, at least three of the vertices having means upon which the track can move.

18. The device according to claim 17, wherein one of the vertices is linked to the motorized drive module.

19. The device according to claim 17, wherein the motorized drive module is coupled to the track on a side of the parallelogram.

20. A lightweight vehicle, comprising:
a frame;
a single main a single main platform for a user in a substantially upright position mounted to a top of the frame;
a motor mounted to the frame;
a track carriage mounted to the frame;
an endless loop track having a lower run beneath the track carriage and an upper run, the track carriage bearing upon the lower run of the track;
a drive coupling the endless loop track to the motor to drive the track;
a pair of auxiliary platforms mounted on a retractably mount on a first and second side of the frame, the retractable mount adapted to maintain the auxiliary platforms in a raised and lowered positions, wherein the lowered position raises the endless loop track above a plane formed by the auxiliary platforms; and
a ski rotatably coupled to the frame, said ski being adapted to steer the vehicle.
